(19) United States
(12) Patent Application Publication
(10) Pub. No.: US 2014/0245915 A1
(43) Pub. Date: Sep. 4, 2014

(54) Method for Making Tools

(71) Applicant: Da-Sen LIN, Taichung City (TW)

(72) Inventor: Da-Sen LIN, Taichung City (TW)

(21) Appl. No.: 13/783,279

(22) Filed: Mar. 2, 2013

(51) Int. Cl. B41F 23/00

(52) U.S. Cl. CPC B41F 23/00
USPC 101/483

(57) ABSTRACT

A simple and inexpensive method is devised for marking a tool. In the method, a tool is provided. Then, a coating is provided on the tool. Then, a printed layer is provided on a portion of the coating. Finally, a protective layer is provided on at least the printed layer.

### BACKGROUND OF INVENTION

1. Field of Invention

The present invention relates to tools and, more particularly, to an inexpensive method for marking tools.

2. Related Prior Art

Tools can be classified as electric tools, pneumatic tools and hand tools. There are various tools such as knifes, scissors, shovels, planes, saws, axes, chisels, clamps, drills, files, harrows, plows, hammers, pliers, wrenches, socket wrenches and screwdrivers. Some tools can be made electric or pneumatic tools. For example, there are electric and pneumatic socket wrenches and screwdrivers.

A socket-wrench toolkit includes a handle and sockets that are made of various sizes. In use, a handle is connected to one of the sockets in detachable manner. The sockets are marked to enable a user to easily select a desired one from them.

Some marks include rubber or plastic rings of various colors. The rings are attached to the sockets. However, the rings can easily be blurred because of oil, grease and/or dirt.

U.S. Pat. No. 8,020,274 discloses a method for marking sockets referring to FIG. 1 as the prior art and another method for marking sockets referring to FIG. 3 as the invention. However, these methods are expensive.

### SUMMARY OF INVENTION

It is an objective of the present invention to provide a simple method for marking tools.

It is another objective of the present invention to provide an inexpensive method for marking tools.

To achieve the foregoing objective, the method includes the steps of providing a tool, providing a coating on the tool, providing a printed layer on a portion of the coating, and providing a protective layer on at least the printed layer.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a flow chart of an inexpensive method for marking tools according to the preferred embodiment of the present invention;

FIG. 2 is a perspective view of a socket of a socket wrench marked by the method shown in FIG. 1;

FIG. 3 is a cross-sectional view of the socket shown in FIG. 2;

FIG. 4 is a side view of a wrench marked by the method shown in FIG. 1;

FIG. 5 is a perspective view of a bit of a screwdriver marked by the method shown in FIG. 1;

FIG. 6 is a perspective view of an ax marked by the method shown in FIG. 1;

FIG. 7 is a perspective view of an extension rod marked by the method shown in FIG. 1; and

FIG. 8 is a perspective view of a screwdriver marked by the method shown in FIG. 1.

### DETAILED DESCRIPTION OF PREFERRED EMBODIMENT

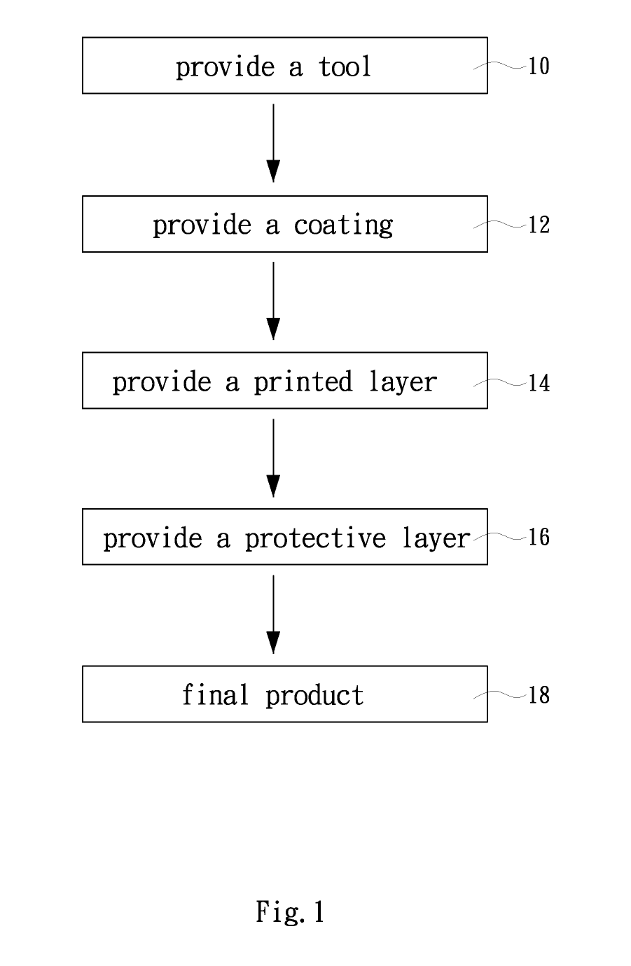

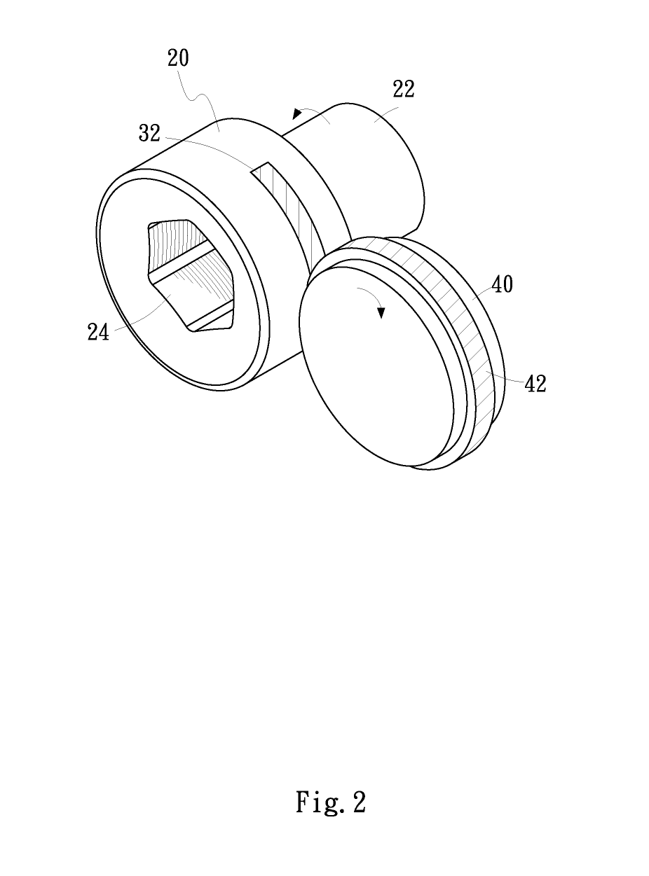

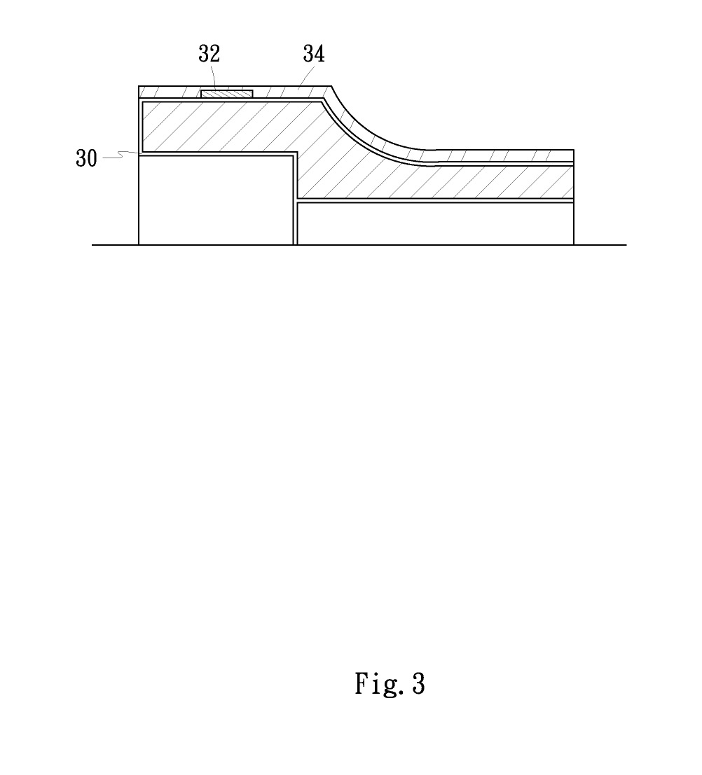

Referring to FIGS. 1 through 3, there is shown an inexpensive method for marking tools according to the preferred embodiment of the present invention. At 10, there is provided a tool 20 in the form of a socket of a socket wrench for example. The tool 20 is made of a sort of metal by punch-molding, lathing or casting. The tool 20 includes two sections 22 and 24. The first section 22 of the tool 20 includes a square cavity for receiving a square tongue or insert of a handle of the socket wrench. The second section 24 of the tool 20 includes a hexagonal cavity of receiving a hexagonal nut, head of a screw or root of a tool bit.

At 12, the tool 20 is provided with a coating 30 of another sort of metal by electroplating for example. The coating 30 keeps the tool 20 from gas and/or liquid to which rust is attributed. Thus, the coating 30 protects the tool 20 from rust.

At 14, a printed layer 32 is provided on the coating 30 by an annular rib 42 formed on a roller 40. To this end, colorant such as ink or paint is provided on the annular rib 42. The coating 30 and the annular rib 42 are brought into contact with each other while the tool 20 is rotated by the roller 40. Thus, the colorant is transferred onto the coating 30 from the annular rib 42. The provision of the printed layer 32 is on the coating 30 does not cause any damage on the coating 30 and therefore the tool 20. The color of the printed layer 32 is in strong contrast to the color of the coating 30. The printed layer 32 may carry at least one line, number, pattern, character, letter, symbol or the like.

At 16, there is provided a protective layer 34 on at least the printed layer 32. The protective layer 34 may be made of organic glass or polymethylmethacrylate (“PMMA”) so that it is very hard, highly transparent and inexpensive and can easily be machined. The protective layer 34 effectively protects the printed layer 32 without the drawbacks of jeopardizing the clarity of the printed layer 32 and unreasonably increasing the cost of the tool 20. The protective layer 34 can be provided only on the printed layer 32 all over of the coating 30.

As discussed above, the method can be used to provide inexpensive tools. The printed layer 32 is effectively protected by the protective layer 34. The integrity of the printed layer 32 will not be damaged when the tool 20 is washed or wiped. Hence, the printed layer 32 can always be read clearly after such washing or wiping.

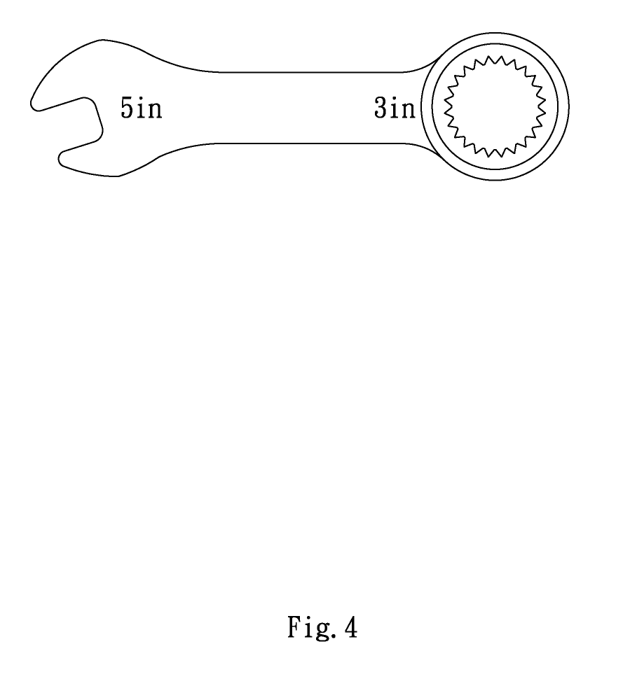

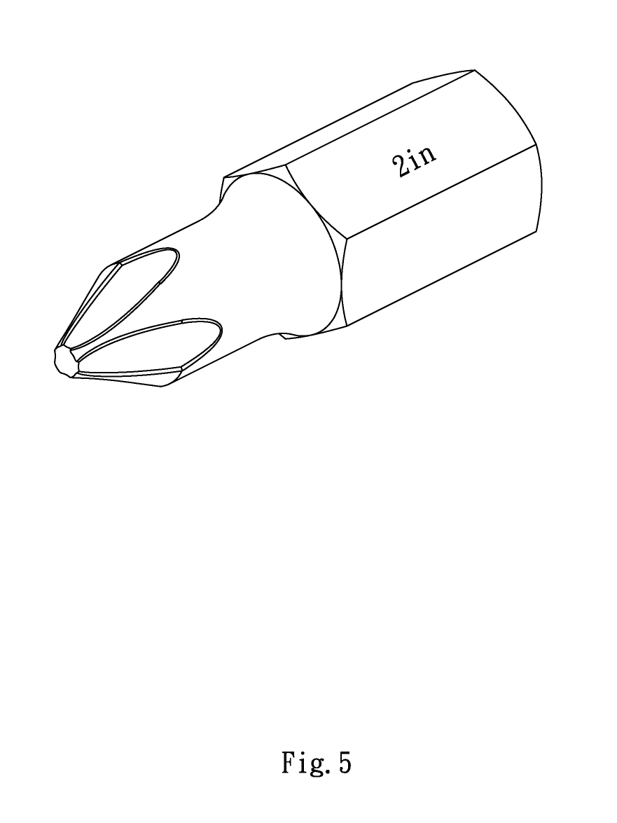

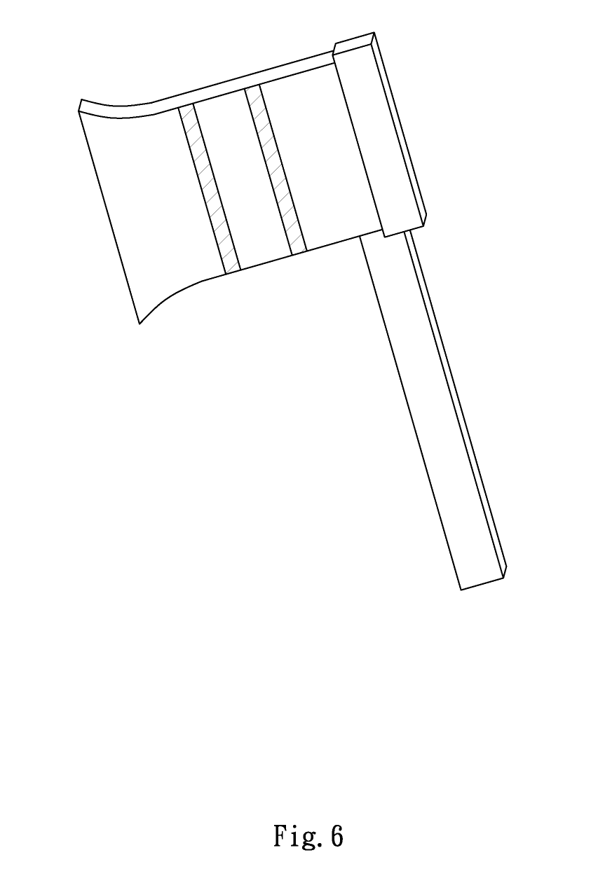

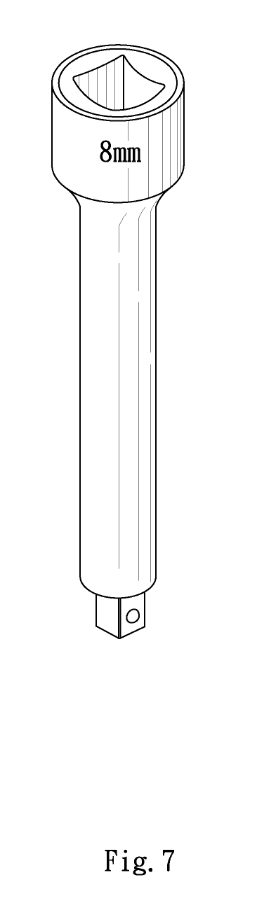

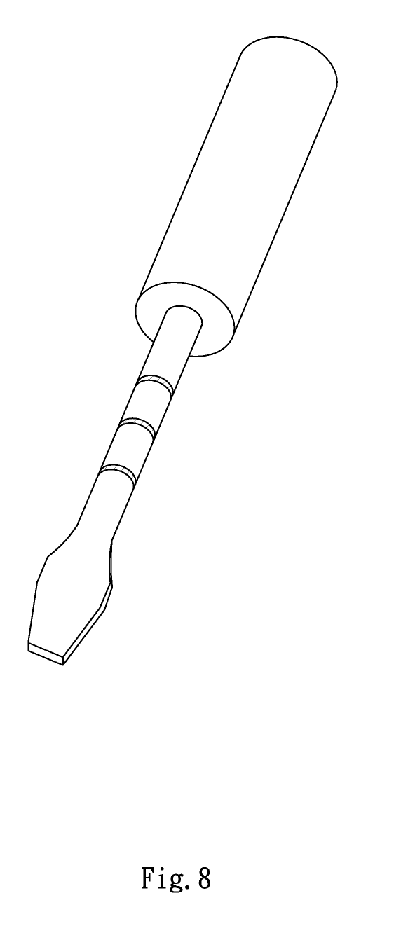

Referring to FIGS. 4 through 8, there are shown various tools that can be marked by the method of the present invention. For example, the method can be executed to mark a wrench as shown in FIG. 4, a bit of a screwdriver as shown in FIG. 5, an ax as shown in FIG. 6, an extension rod as shown in FIG. 7 or a screwdriver as shown in FIG. 8.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A method for marking a tool including the steps of:
providing a tool;
providing a coating on the tool by electroplating;
providing a printed layer on a portion of the coating; and
providing a protective layer on at least the printed layer.

2. The method according to claim 1, wherein the step of providing the tool includes a step selected from the group consisting of punch-molding, lathing and casting.

3. The method according to claim 1, wherein the protective layer is made of a hard and transparent material.

4. The method according to claim 3, wherein the hard and transparent material is selected from the group consisting of organic glass and polymethylmethacrylate.

5. The method according to claim 1, wherein the step of providing the printed layer on the coating includes the step of providing a roller for rolling and transferring colorant onto the coating.

6. The method according to claim 5, wherein the step of providing a roller for rolling and transferring the colorant onto the coating includes the step of providing the roller with an annular rib for contracting and transferring the colorant onto the coating.

7. The method according to claim 1, wherein the step of providing the protective layer on at least the printed layer includes the step of providing the protective layer on the printed layer and all over the coating.

8. The method according to claim 1, wherein the printed layer is selected from the group consisting of a line, number, pattern, character, letter and symbol.

9. The method according to claim 1, wherein the printed layer is made of a color other than that of the coating.

10. The method according to claim 1, wherein the tool is selected from the group consisting of a socket, a wrench, a bit of a screwdriver, an ax, an extension rod and a screwdriver.

11. The method according to claim 3, wherein the step of providing the printed layer on the coating includes the step of providing a roller for rolling and transferring colorant onto the coating.

12. (canceled)

13. The method according to claim 11, wherein the step of providing a roller for rolling and transferring the colorant onto the coating includes the step of providing the roller with an annular rib for contracting and transferring the colorant onto the coating.

14. The method according to claim 11, wherein the step of providing the protective layer on at least the printed layer includes the step of providing the protective layer on the printed layer and all over the coating.

15. The method according to claim 11, wherein the printed layer is selected from the group consisting of a line, number, pattern, character, letter and symbol.

16. The method according to claim 11, wherein the printed layer is made of a color other than that of the coating.

17. The method according to claim 11, wherein the tool is selected from the group consisting of a socket, a wrench, a bit of a screwdriver, an ax, an extension rod and a screwdriver.

18. The method according to claim 11, wherein the hard and transparent material is selected from the group consisting of organic glass and polymethylmethacrylate.
